(19) United States
(12) Patent Application Publication
(10) Pub. No.: US 2011/0090231 A1
(43) Pub. Date: Apr. 21, 2011

(54) ON-LINE ANIMATION METHOD AND ARRANGEMENT

(76) Inventor: Erkki Heilakka, Helsinki (FI)

(21) Appl. No.: 12/580,779

(22) Filed: Oct. 16, 2009

(51) Int. Cl. G06F 13/14; G06T 13/00

(52) U.S. Cl. 345/473; 345/520

(57) ABSTRACT

The arrangement has a first computer arranged to be in data communication with a second computer. The arrangement has a device for receiving from a second computer a editable version of animation data sufficient for rendering visually simplified animation in the second computer. The editable version of animation data has at least one reference to additional data for the purpose of forming animation in the second computer, and forming in the first computer a renderable or rendered version of animation data by combining the editable version of animation data with the referenced additional data.

### TECHNICAL FIELD OF INVENTION

The present invention relates to a method, arrangement and computer software product for producing animations in a networked computer system.

### BACKGROUND AND SUMMARY OF THE INVENTION

Various methods for producing animation, e.g. character animation, in networked computer systems are known in the prior art.

For example, PCT publication WO2008118001A1 discloses a program designed master animation (PDMA) and a method for its production. The method uses frame information as the construction units of the animation. A user may combine a set of existing frame information into a new animation.

Korean patent application KR20000037456 discloses a method for implementing character animations through the computer network in real time. In the method, a user is connected to an animation server through a network terminal such as a personal computer. The animation server, as an interface for users to provide a web page suitable for www environment and to carry out overall management for character animations required by the users, is connected with an animation database to transmit and receive animation data generated by an animation data writing tool. A character writing tool as a program to manufacture a desired character directly in the user side is stored in the network terminal of the user side.

The solutions known in the prior art are not optimal for the purpose of producing animated digital content in a networked, preferably multi-user computer system.

For example, the complete animation information, e.g. geometrical information and texture data, of an animation scene is quite complex, memory consuming and computationally demanding. Therefore, it is not optimal for applications where the information needs to be frequently modified and processed, e.g. when producing animation in at least one, but possibly multiple terminal computers, or transferred in a real-time or near real-time fashion between the server computer and one or more terminal computers. The methods and arrangements known in the prior art are also unsuitable for producing animation efficiently in a multi-user environment where a plurality of users may work concurrently on the same animated scene, possibly using terminals whose capabilities are limited and which are thus not sufficient for producing high-quality rendered animation.

One object of the present invention is to provide a method, arrangement and computer software product for efficient production of digital content comprising animation in a system comprising a plurality of networked computers.

The first aspect of the present invention is an arrangement for rendering animation of an animated scene, the arrangement has a first computer arranged to be in data communication with a second computer. The arrangement is characterized in that it has means for receiving from at least one second computer an editable version of animation data sufficient for rendering a visually simplified version of the animation in the second computer, the editable version of animation data has at least one reference to additional data e.g. for the purpose of forming animation data in the first computer, and for creating in the first computer by combining the editable version of animation data with the referenced additional data at least one of the following: a renderable version of animation data and a rendered final animation.

The animation may e.g. be a character animation. Advantageously, the animation is three-dimensional character animation.

In an embodiment, the first computer is a server computer and the second computer is a terminal computer. The first computer may also have a plurality of communicatively connected computers.

Preferably, the editable version is in a first data format and the renderable version is in a second data format. The first format may be optimized e.g. for animation editing purposes on a terminal possibly with a limited processing capability and the second format may be optimized e.g. for animation rendering purposes on the server. In an embodiment, at least some items, e.g. the animation control data items, in the editable version are associated with a timestamp. In an embodiment, the arrangement has means for converting the animation data from the first format to the second format.

The visually simplified version of the animation may for example be a version that has reduced number of details, e.g. surface textures, in the animated characters and/or scene of the animation in comparison to the rendered version produced e.g. by the first computer of the arrangement.

In an embodiment, the first computer has means for sending to a third computer, e.g. another terminal computer, the editable version received from the second computer. The sending may occur e.g. in real-time or in near real-time fashion. The third computer may have means for combining data of the editable version received from the first computer with data of the editable version produced by the third computer e.g. in a chronological order according to the timestamp data of the editable versions. The objects received by the third computer may be treated, e.g. displayed, as read-only data in the third computer.

In an embodiment, the first computer has means for sending to a third computer the renderable version formed from the editable version received from the second computer.

In an embodiment, the editable version of animation data has any of the following: location information of an animated object in an animation scene, movement information of an animated object in an animation scene, object and environment declarations, object transformations, object motion or transformation sequences, speech acts, sound effects bound to a location in the animated scene and sound effects not bound to any location.

In an embodiment, the renderable version of animation data has any of the following: information about structural elements, such as points, planes and surfaces of an animated object, information about visual surface characteristics of the structural elements of an animated object and information about the audio components, e.g. the speech acts and sound effects, of the animated scene.

In an embodiment, a plurality of frames arranged to be presented as an animation. The frames may be rendered by the first computer using the renderable version of the animation data.

In an embodiment, the arrangement further has in the first computer means for receiving from a third computer a second editable version of animation data of the same animated scene, optionally determining and resolving dependencies and/or conflicts between the first editable version and the second editable version, and combining from the first editable version and the second editable version a third editable version and/or the renderable version of animation data. The combining of the animation data of the first and second editable versions is preferably performed by utilizing the timestamp information of the animation data of the first and second editable versions. As a result, the combined animation data may be arranged in a chronological order.

The second aspect of the present invention is a method for rendering animation in a first computer arranged to be in data communication with a second computer. The method is characterized in that it has steps of receiving from a second computer a editable version of animation data sufficient for rendering a visually simplified version of the animation in the second computer, the editable version of animation data has at least one reference to additional data e.g. for the purpose of forming animation in the first computer, and creating in the first computer by combining the editable version of animation data with the referenced additional data at least one of the following: a renderable version of animation data and a rendered final animation.

The third aspect of the present invention is a computer software product for rendering animation in a first computer arranged to be in data communication with a second computer. The software product is characterized in that it has computer executable instructions for receiving from a second computer a editable version of animation data sufficient for rendering a visually simplified version of the animation in the second computer, the editable version of animation data has at least one reference to additional data e.g. for the purpose of forming animation data in the first computer, and for forming in the first computer by combining the editable version of animation data with the referenced additional data at least one of the following: a renderable version of animation data and a rendered final animation.

Some embodiments of the present invention are described herein, and further applications and adaptations of the invention will be apparent to those of ordinary skill in the art.

### BRIEF DESCRIPTION OF THE DRAWINGS

In the following, the invention is described in greater detail with reference to the accompanying drawings in which

FIG. 1 shows an exemplary arrangement according to an embodiment of the present invention,

FIG. 2 shows an exemplary flow chart according to an embodiment of the method of the present invention, and

FIG. 3 shows an exemplary flow chart according to another embodiment of the method of the present invention.

### DETAILED DESCRIPTION

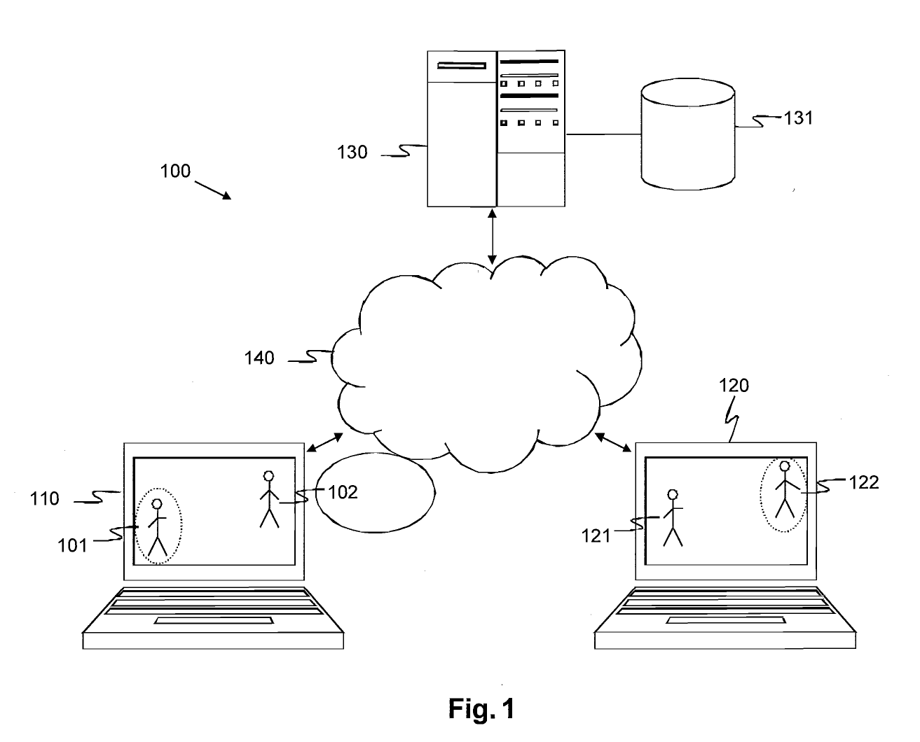

FIG. 1 depicts an exemplary arrangement according to an embodiment of the present invention. The arrangement 100 has a first terminal 110 and a second terminal 120 communicatively connected to a data communication network 140, e.g. the Internet. The arrangement also comprises a server computer 130 to which the terminals 110, 120 are communicatively connected via the communication network 140. The server computer is connected to a database that contains the additional referred data usable for rendering animation according to animation instructions (i.e. the editable version) obtained from the terminals 110, 120. Each terminal runs a software program suitable for producing animation instructions of an animated scene. The production of an animated scene may occur in collaboration with at least one other terminal. The user of a terminal 110 animates or controls at least one object 101 of the animated scene. The user of a terminal 110 also sees animated objects controlled by other users. For example, the user of terminal 120 controls object 122 of which a copy is shown as object 102 on terminal 110. The circle around an animated object 101, 122 illustrates an object that is controllable by the user of the respective terminal 110, 120. Similarly, the user of the terminal 120 may see a copy of object 101, controlled by the user of the terminal 110, as an object 121 depicted on the terminal 120.

The server 130 has means, e.g. software program code, for producing a renderable version of the animated scene using the animation instructions from terminals 110 and 120 as well as information obtainable from the database 131 as input.

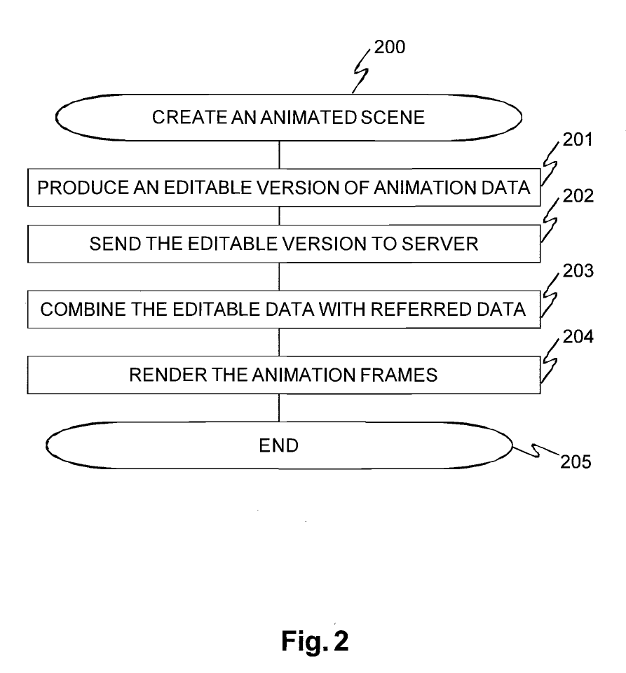

FIG. 2 depicts an exemplary flow chart of an embodiment of the method of the present invention. In the method 200, an editable version of animation data is first produced in step 201 in the terminal (e.g. terminal 110 in FIG. 1). The editable version contains control information and references to information residing in the network, e.g. in the database (such as database 131 in FIG. 1). The editable version, also referred herein as an animation control file, is e.g. in a proprietary markup file format, which is preferably based on XML (eXtensible Markup Language). Animation control files contain animation control data, e.g. object level control items, including objects' properties, positions, movements, actions, transformations, speech acts and other voice definitions. The information of the control file is sufficient for producing a visually simplified (e.g. having a coarse appearance), efficiently editable animation in a terminal computer. Each control item is preferably associated with a timestamp. For example, an item I1 can state that an object O1 is in a location (X1, Y1, Z1). Another item I2 regarding the same object can state that O1 is moving to direction (X2, Y2, Z2) with a speed S and, during the movement, O1 is performing transformation T1. Yet another item I3 can state that O1 disappears from the scene. The animation control files preferably do not contain any description of objects, only references to objects and other resources. Animation control files also refer to scene description documents. The references are preferably in the URL (Universal Resource Locator) format.

The animation control file formed in the terminal computer is then sent in step 202 to the server computer (e.g. server 130 in FIG. 1) for further processing.

A scene description document describes the environment for an animation. An environment can be a room with furniture or an open grassy field, for example. Scene description documents are in another proprietary file format, which is also preferably based on XML. The documents may be located in a remote server. Preferably, the scene description information is used when forming, e.g. rendering, the renderable version of the animation using the server computer. A simplified version of the scene description information may be composed for use in the terminal computer. Both the full and the simplified version of the scene description information may be stored in the same scene description document. Preferably, however, only the simplified version of the information is usually sent to the editing terminal computer.

In the following, an example of a scene description is provided. A scene may for example have two objects: a lawn and a tree. In the simplified version of the scene description information, the objects are represented in a greatly simplified manner. For example, the lawn may be represented as a green area, e.g. as isometrically projected tiles, and the tree may be a visually simplified representation of a tree. Such information is not computationally intensive and is thus suitable in the animation design phase that occurs in the terminal(s) of the arrangement. In the detailed version of the scene, the objects are represented in significantly more detailed manner. For example, the lawn may be represented using a texture which may have e.g. a photographic image of a lawn or a programmatically computed “virtual lawn”. The tree may be represented using a complex 3D model that has e.g. leaf and bark textures which may be e.g. bit maps.

The description of the details of the animated objects (e.g. three-dimensional models, textures, motion capture data) and other resources, e.g. audio components, e.g. voices and sound effects, reside in separate documents. They are preferably also located in a remote server (e.g. server 130 in FIG. 1). The documents and resources are in various formats, depending on the type of resource. A three-dimensional model can be in the The3dStudio.com™ 3DS format or in the COLLADA format, for example. The format of a texture can be JPEG or GIF, for example. The format of an audio component may be e.g. MP3.

Once the server receives the editable version, a renderable version is produced in the server by combining the content of the editable version and the content of the referred information as shown in step 203. A computer program takes an animation control file and referred resource documents as an input, combines the information of the documents, and outputs the renderable version of the animation definition.

Finally a set of frames forming the animated digital content is rendered in step 204. In this step, the renderable version of the animation definition produced in step 203 is used as input format. The document produced in step 203 contains the information required for rendering individual frames (i.e. image files) of the animation. The format of the document may be e.g. Renderman® RIB (RenderMan Interface Bytestream Protocol) or other suitable animation definition format. The rendered frames may be in the JPEG format, for example. The frames are given as an input to a third computer program that encodes the frames to a video file (i.e. MPEG or QuickTime) together with the audio components of the animation. Typically, the audio components have a timestamp according to which the component is included in the video file. The audio components may be e.g. speech acts or sounds caused by the various acts, e.g. walking, of the animated characters. The sounds may be bound to a specific location, e.g. to the location of an animated character, within the animation scene.

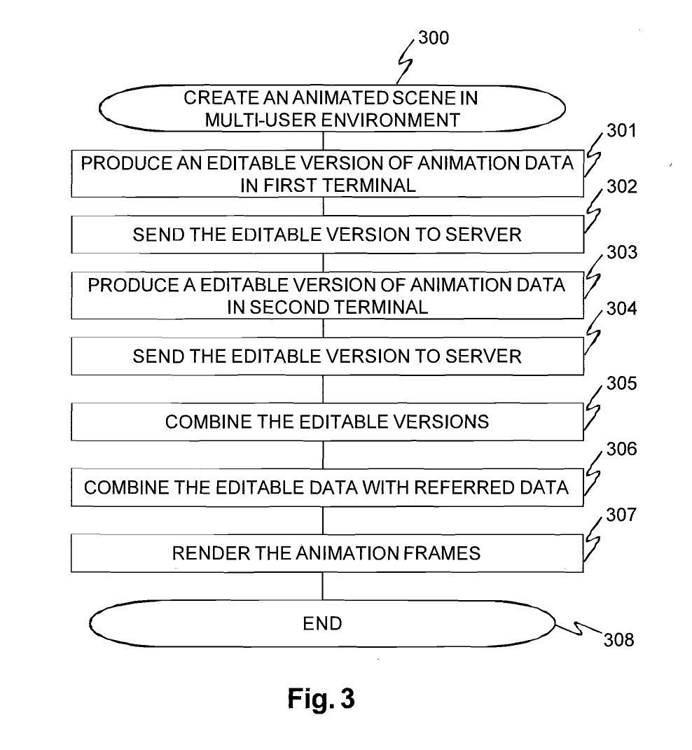

FIG. 3 depicts another embodiment 300 of the method of the present invention. The embodiment concerns a method for creating animation in a networked system that comprises a first terminal (such as terminal 110 in FIG. 1), a second terminal (such as terminal 120 in FIG. 1) and a server (such as server 130 in FIG. 1). A first editable version is produced in step 301 in the first terminal and sent to the server in step 302. A second editable version is produced in step 303, preferably concurrently with the first editable version, in the second terminal and sent to the server in step 304. The first and the second editable versions contain control information with timing information (e.g. timestamps associated with each animation control data item) and references to documents residing in the network. A third editable version is produced in the server by combining in step 305 the content of the first editable version and the second editable version by synchronizing the content using the timing (timestamp) information. The third document thus contains the animation control data items of the first and the second editable versions arranged in chronological order. Then, renderable version of animation definition is produced in the server by combining in step 306 the content of the third editable version and the content of the referred documents, and the animation is rendered in step 307 according to the renderable version of the animation definition. This completes in step 308 the method.

The first, second and third editable versions are in the animation control file format described above. The third editable version is only a combination of the first and the second editable versions. The control items of the first and second editable versions are appended chronologically to the third document according to the timestamps associated to the control items. In an embodiment, the third editable version can be by-passed and both the first document and the second document are given as an input to the computer program that forms the renderable version of the animation definition, that then acts as the input for the render process.

In an embodiment, the creation of the (intermediate) renderable version may be by-passed and the final rendered version of the animation is created based on the information of e.g. the third editable document and the documents referred from the third editable document.

To a person skilled in the art, the foregoing exemplary embodiments illustrate the model presented in this application whereby it is possible to design different methods and arrangements, which in obvious ways to the expert, utilize the inventive idea presented in this application.

While the present invention has been described in accordance with preferred compositions and embodiments, it is to be understood that certain substitutions and alterations may be made thereto without departing from the spirit and scope of the following claims.

1. An arrangement for rendering animation of an animated scene, comprising:
an arrangement having a first computer arranged to be in data communication with a second computer,
means for receiving from the second computer an editable version of animation data sufficient for rendering visually simplified animation in an originating computer, the editable version of animation data comprising at least one reference to additional data for a purpose of forming animation in the first computer, and
means for creating in the first computer by combining the editable version of animation data with the additional data a renderable version of animation data and/or rendered animation.

2. The arrangement according to claim 1 wherein the first computer is a server computer.

3. The arrangement according to claim 1 wherein the second computer is a terminal computer.

4. The arrangement according to claim 1 wherein the editable version of animation data comprises a location information of an animated object in an animation scene, a movement information of an animated object in an animation scene, an action of an animated object, a transformation of an animated object, and/or a speech act of an animated object.

5. The arrangement according to claim 1 wherein the renderable version of animation data comprises:
information about structural elements,
information about visual surface characteristics of the structural elements of an animated object, and/or
information about the audio components of the animated scene.

6. The arrangement according to claim 1 wherein the arrangement comprises means for forming from the renderable version of animation data a plurality of frames arranged to be presented as an animation.

7. The arrangement according to claim 1 wherein the editable version of animation data used as input is formed by combining animation data of a plurality of editable versions in chronological order according to the timestamp information of the animation data of the editable versions.

8. An method for rendering animation of an animated scene in a first computer arranged to be in data communication with a second computer, comprising:
receiving from a second computer a editable version of animation data sufficient for rendering visually simplified animation in the second computer, the editable version of animation data comprising a reference to additional data, and
creating in the first computer by combining the editable version of animation data with the referenced additional data a renderable version of animation data and/or rendered animation.

9. A computer software product for rendering animation of an animated scene in a first computer arranged to be in data communication with a second computer, the computer software product comprises computer executable instructions for:
receiving from a second computer a editable version of animation data sufficient for rendering visually simplified animation in the second computer, the editable version of animation data comprising a reference to additional data, and
creating in the first computer by combining the editable version of animation data with the referenced additional data a renderable version of animation data and/or rendered animation.
